(19) United States
(12) Patent Application Publication
(10) Pub. No.: US 2024/0112013 A1
(43) Pub. Date: Apr. 4, 2024

(54) Generative Models for Discrete Datasets Constrained by a Marginal Distribution Specification

(71) Applicant: Google LLC, Mountain View, CA (US)

(72) Inventors: Hanjun Dai, San Jose, CA (US); Bo Dai, San Jose, CA (US); Mengjiao Yang, Berkeley, CA (US); Yuan Xue, Palo Alto, CA (US); Dale Eric Schuurmans, Edmonton (CA)

(21) Appl. No.: 17/951,889

(22) Filed: Sep. 23, 2022

(51) Int. Cl. G06N 3/08; G06N 3/04

(52) U.S. Cl. CPC G06N 3/08; G06N 3/0472

(57) ABSTRACT

The present disclosure is directed to generative models for datasets constrained by marginal constraints. One method includes receiving a request to generate a target dataset based on a marginal constraint for a source dataset. A first object occurs at a source frequency in the source dataset. The marginal constraint indicates a target frequency for the first object. The source dataset encodes a set of co-occurrence frequencies for a plurality of object pairs. A source generative model is accessed. The source generative model includes a first module and a second module that are trained on the source dataset. The second module is updated based on the marginal constraint. An adapted generative model is generated that includes the first module and the updated second module. The target dataset is generated based on the adapted generative model. The first object occurs at the target frequency in the target dataset. The target dataset encodes the set of co-occurrence frequencies for the plurality of object pairs.

### FIELD

The present disclosure relates generally to machine learning. More particularly, the present disclosure relates to generative models for discrete data sets constrained by a marginal distribution specification via module-oriented divergence minimization.

### BACKGROUND

Discrete sets are a common datatype in real world applications, typically encountered, for example, in checkout carts for e-commerce sites, sets of diagnosis codes for individual patients in their electronic health records (EHR), or even bag-of-word representations of documents. Understanding correlations between set elements provides essential insight in these (and other) domains and has been a major topic in machine learning and data mining research. Deep generative models, including deep latent variable models, autoregressive models, and deep energy-based models, have recently provided powerful new tools for capturing high-order correlations between elements co-occurring in a set. Generated samples of discrete sets from such models, such as synthetic online orders, are often used for evaluating downstream decisions in applications like supply chain fulfillment and product assortment decisions.

Generative models have demonstrated success in discrete set modeling for domains such as document and language modeling, but these successes have generally relied on a basic assumption: that the target distribution matches the distribution that generated the training data. However, distribution shift is prevalent in real-world scenarios, which can cause poor alignment between previously sampled training data and a current target distribution. One typical reason for such drift is seasonality, for example sales in summer differ from those in winter. Another reason is the need to perform counterfactual simulation for purposes like debiasing EHR data or stress-testing logistic systems. Both cases require the generative model to be adapted to satisfy a (possibly counterfactual) target data distribution.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method includes, receiving, at a computing device, a request to generate a target dataset. The request may request a target dataset that is based on a marginal constraint for a source dataset. The source dataset may be associated with a plurality of objects. A first object of a plurality of objects may occur at a source frequency in the source dataset. The marginal constraint may indicate a target frequency for the first object that is separate from the source frequency. The source dataset may encode a set of co-occurrence frequencies for a plurality of object pairs of the plurality of objects. The method may further include accessing, at the computing device, a source generative model. The source generative model may include a first set of modules. (e.g., at least a first set of modules including a first module and a second module). Each module of the first set of modules is trained on the source dataset. The computing device may update the second module based on the marginal constraint. The computing device may generate an adapted generative model. The adapted generative model may include a second set of modules. The second set of modules may include the first (frozen or non-updated) module and the updated second module. The computing device may generate the target dataset. Generating the target dataset may be based on the adapted generative model. The first object may occur at the target frequency in the target dataset. The target dataset may encode the set of co-occurrence frequencies for the plurality of object pairs.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of a motivating (but non-limiting) example application a Module-Oriented DivErgence Minimization-based framework employed by various embodiments;

FIG. 2 depicts a block diagram of an example environment that enables marginal distribution adaptation for discrete sets via module-oriented divergence minimization, according to various embodiments;

FIG. 3 depicts a flowchart diagram of an example method for generating a target distribution based on a source distribution and a marginal constraint according to example embodiments of the present disclosure; and

FIG. 4 depicts a flowchart diagram of another example method for generating a target distribution based on a source distribution and a marginal constraint according to example embodiments of the present disclosure.

Reference numerals that are repeated across plural figures are intended to identify the same features in various implementations.

### DETAILED DESCRIPTION

### Overview

Distributions over discrete sets capture the essential statistics including the high-order correlation among elements. Such information provides powerful insight for decision making across various application domains, product assortment based on product distribution in shopping carts. While deep generative models trained on pre-collected data can capture existing distributions, such pre-trained models are usually not capable of aligning with a target domain in the presence of distribution shift due to reasons such as temporal shift or the change in the population mix.

Accordingly, the embodiments are directed towards a pipeline (e.g., a framework and/or workflow) that adapts a generative model subject to a target data distribution with both sampling and computation efficiency. The target data distribution may include one or more counterfactual target data distributions. Rather than re-training a full model from scratch, the embodiments reuse the learned modules to preserve the correlations between set elements, while adjusting corresponding components to align with target marginal constraints. The embodiments instantiate the approach for at least three forms of discrete set distribution: (1) latent variable, (2) autoregressive, and (3) energy-based models. The embodiments provide efficient solutions for marginal-constrained optimization in either primal or dual forms. The pipeline (or framework) is enabled to align a generative model to match marginal constraints under distribution shift.

For discrete sets, one statistic of interest includes element marginals (e.g., the occurrence frequency of a particular element in the generated sets). In general, it may be more straightforward to determine estimates of element marginals (e.g., sales for a certain product or prevalence of a certain disease) relative to determining joint occurrence statistics. To such ends, the embodiments efficiently align a generative model to match target marginal specifications, while preserving previously learned correlations between elements of a training dataset that includes training distributions.

Conventional approaches for generating a discrete distribution subject to a new constraint (e.g., a new marginal specification) include retraining an entire generative model from scratch on data that respects the new marginal specification. However, such conventional approaches may be significantly inefficient in terms of sample, memory, and computational resource use. Other conventional approaches include fine-tuning a pretrained generative model. Such “fine-tuning” conventional approaches typically employ an existing generative model as a warm-start, to fully retrain the model on new data reflecting the target distribution. Such conventional approaches update all model parameters in a generative model during gradient-based retraining. Such retraining gives rise to computational inefficiencies. Furthermore, in these conventional approaches, there may be no simple mechanism for preserving previous correlations without accessing the original training data. Contemplating these conventional approaches reveals a delicate trade-off between training efficiency and model reuse.

To address these and other inadequacies of conventional approaches, the embodiments adapt a pre-trained generative model to match target marginals while preserving previous correlations in the dataset that was employed to pretrain the generative model. It will be shown herein that this approach generates the new distributions significantly more efficient, and improves the performance of the generation, as compared to the conventional approaches. The pipeline, workflow, and/or framework of the embodiments may be referred throughout as a Module-Oriented DivErgence Minimization-based framework, or simply as the MODEM. The following discussions are directed towards marginal distribution adaptation. However, the embodiments are not so limited, and the MODEM framework is far more general and may be applied to other distribution alignment problems.

Aspects of the present disclosure provide a number of technical effects and benefits. For instance, the MODEM framework employs a constrained divergence minimization method that achieves greater efficiency and improved generation of novel distributions subject to one or more constraints. The MODEM framework achieves greater efficiencies for marginal matching, under all three generative model types: latent variable models, autoregressive models, and energy-based models.

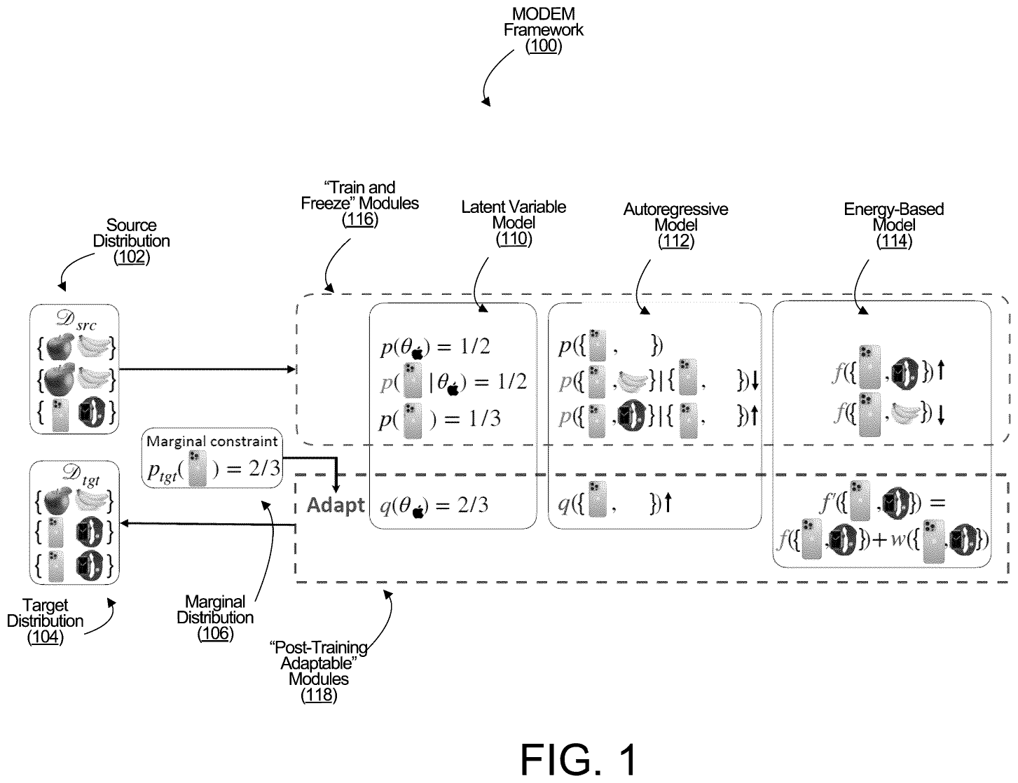

FIG. 1 depicts a block diagram of a motivating (but non-limiting) example application of the Module-Oriented DivErgence Minimization (MODEM) framework 100 employed by various embodiments. In this non-limiting example, the MODEM framework 100 is applied to online shopping at an e-commerce platform (e.g., an online store) that sells both fruits and electronics. As an input, the MODEL framework 100 receives a source distribution 102 as an input. The source distribution 102 may be referenced as [symbol] _{src}. Because the source distribution 102 is employed to train models, the source distribution may be referred to throughout as a target distribution. The source distribution 102 includes a source (or training) discrete set. The elements of the source discrete set include the items in its customers' checkout carts in a typical or regular day, e.g., on typical days, the store sells more fruits than electronics. Encoded in the source distribution 102 are correlations of what items are bought together. For instance, if a customer buys an apple, the probability of the customer also buying a banana may be inferred from the item correlations. Similarly, if a customer buys a smartphone, the probability of the customer also buying a smartwatch may be inferred from the item-correlations. The party operating the store would like to simulate orders around the time of a new smartphone release for a popular brand of smartphones. The simulated orders are encoded in a target distribution 104 generated by the MODEM framework 100. The target distribution 104 may be referenced as [symbol] _{tgt}. The target distribution 104 includes a target discrete distribution (of the simulated orders) that is generated by the MODEL framework 100. The target distribution 104 preserves the item correlations encoded in the source distribution 102 (e.g., apples and bananas co-occur, smartphones and watches co-occur). According to various polls, approximately ⅔ of the general population buys a new smartphone around the time of release according to some poll. The knowledge that ⅔ of the store's customers (e.g., a population) buys a new smartphone around the time of the popular brand's release may serve as a non-limiting example of a marginal constraint 106.

The embodiments may employ a latent variable model (LVM) 110 that adapts to the marginal constraint by controlling the latent variable representing the electronics category. The embodiments may employ an autoregressive model 112 that increases the probability that the first generated element (e.g., in a generated discrete distribution) is the new smartphone. The embodiments may employ an energy-based model (EBM) 114 that adapts the energy to generate more smartphones in the generated distribution. As will be described in fuller detail below, each of the three model-types includes a plurality of modules. Some of the modules are trained on the source distribution 102 and “frozen” and reused to generate the target distribution 104 based on the marginal distribution 106. These modules may be referred to as “train and freeze” modules and are indicated by the upper dashed box 116. Other modules of the models are adapted after the training on the source distribution 102. These modules may be referred to as “post-training adaptable” modules and are indicated by the lower dashed box 118.

The following discussion initially provides a formal introduction to the problem of distribution adaptation. The next portion of the following discussion recasts distribution adaptation as a constrained divergence minimization problem. The MODEM embodiments explicitly reuse modules from a pretrained generative model to preserve previously learned correlations (e.g., the train and freeze modules of FIG. 1). The MODEM framework integrates and balances the trade-offs associated with twin (and competing) goals of computational efficiency and the reuse of modules from previously trained generative models (e.g., the post-training adaptable modules of FIG. 1). The term modules may be used throughout to refer to distributions and/or statistical models.

### Problem Formulation

A discrete set S is defined as a collection of unique elements from a finite domain X={x₁, x₂, . . . , x_{|X|}}. A set defined over a domain may be included in the powerset of the domain, e.g., S∈ [symbol] (X) where [symbol] (X) is the powerset of X. Given a dataset sampled from some unknown source distribution [symbol] _{src}˜p(X), a generative modeling task may include learning a model (e.g., q) from a parametrized distribution family (e.g., [symbol] ) to approximate the unknown source distribution p(S).

Various embodiments are directed towards generative model adaptation under marginal distribution specification. Generative model adaptation under marginal distribution specification may include, given a learned model (e.g., p∈ [symbol] ), the embodiments generate another model (e.g., q∈ [symbol] ) that satisfies the marginal distribution specification, while one or more original correlations (e.g., correlations present in p) are conserved in q.

A marginal distribution may be specified as:

| [symbol] _{S˜q}[ [symbol] (eᵢ∈S)]−tᵢ|=0,∀(eᵢ,tᵢ)∈C, (1)
where C={cᵢ=(eᵢ,tᵢ)}ᵢ₌₁^{|C|} specifies that a certain element cᵢ∈X would in expectation appear in a 0≤tᵢ≤1 fraction of all the generated discrete sets.

As noted, within the generated discrete sets, the correlations amongst the elements is “conserved” or “preserved” from the source discrete set. Such “correlation preservation” may include that the higher-order moments that should be approximately maintained. This may be stated more formally as:

|Eₚ[I(A∈S)]−E_{q}[I(A∈S)]|≤ξ∀A∈P(X) and |A|>2, (2)
where ξ>0 and Aₖ denotes the subset of S with k-cardinality.

### Divergence Minimization

Conventional methods may approximate a target distribution p based on another distribution (e.g., q) by approximating all higher order moments. However, because the number of constraints (e.g., constraints that ensure the at least approximation of of conserving the correlations) scales faster than exponential scaling with respect to |X|, such conventional approaches may be computationally intractable. The number of correlation-preserving constraints may be reduced by considering only the largest differences between the higher-order moments,

$${max}_{\vert A \vert > 1} {}_{p} A ∈ S - {}_{q} A ∈ S \leq ξ , \qquad ( 3 )$$

where ξ represents a difference threshold. However, the computational complexity associated with this conventional approach is exponential (and thus still computationally intractable) because of the condition of {|A|>1}. However, this approach may be leveraged because it establishes a connection to total variation distance, which provides a path towards tractable optimization, as discussed below.

A total variation distance may be written, in a variational form, as:

$${d}_{TV} p , q = {max}_{h ∈ {ℱ}_{∞}} {𝔼}_{p} [ h ( S ) ] - {𝔼}_{q} [ h ( S ) ] , \qquad ( 4 )$$

where [symbol] ={h∥h∥_{∞}≤1}≤1 denotes the set of functions whose infinity norm is bounded by 1. Therefore, the requirement is relaxed such that the test set A is constrained by A≥1 in correlation preservation condition above, then the computation of the total-variation distance is simplified, such that d_{TV}(p,q)p,q≤ξ is a sufficient condition. Thus, following the above derivation, the embodiments employ a reformulation of the model adaptation problem as a constrained optimization:

$${min}_{q ∈} {d}_{T V} p , q . \qquad ( 5 )$$

Equation (5) may be subject to the condition that:

| [symbol] _{S˜q}[ [symbol] (eᵢ∈S)]−tᵢ|≤ε,∀(eᵢ,tᵢ)∈C,
where ε is a constant for relaxing the constraints, which can be zero if all the marginals must be exactly satisfied.

The above reformulation of the model adaptation problem provides a framework for generative adaptation of distributions, where the marginal constraints serve as the hints for target domain. In some embodiments, to further reduce the computational complexity, Pinsker's inequality

$$( e . g . , {d}_{TV} p , q \leq \sqrt{\frac{1}{2} KLq ‖ p} , ) ,$$

may be applied to obtain a more tractable “surrogate” objective:

$${min}_{q ∈ ℋ} K L ( q ‖ p ) . \qquad ( 6 )$$

Equation (6) may be subject to the condition that:

| [symbol] _{S˜q}[ [symbol] (eᵢ∈S)]−tᵢ|≤ε,∀(eᵢ,tᵢ)∈C.

The above optimization view provides a tractable path to exploit the pretrained model p to preserve the previously learned correlations as much as possible in q while adapting to the target marginals.

### Module Reusable Parameterization

With the proposed divergence minimization view of the more tractable surrogate objective defined above, some embodiments may apply arbitrarily deep probabilistic density models for parametrizing q. In these embodiments, a new model may be trained from a random initialization. Other embodiments further reduce the computational complexity by exploiting the structure of specific but still flexible model classes. Such embodiments may preserve existing modules in a pretrained model. As is shown, preserving existing modules in a pretrained model avoids the training of a new model starting from a random initialization, and this further reduces the computational complexity. In these embodiments, incrementally modified existing modules (from a pretrained model) may be combined, which can significantly save computational and sample complexity.

For different generative model classes, effective techniques for composing a new model from pretrained modules may be different. Below, the MODEM framework is discussed for three separate and powerful model classes: (1) latent variable models, (2) autoregressive models, and (3) energy-based models for discrete set modeling. In each case, we derive the efficient algorithms for solving Eq (6), in either the primal or dual forms.

### The MODEM Framework for Latent Variable Models

Latent variable models (LVMs) may be used for generative modeling of documents and images, as well as unordered sets. For ease of representation, a binary vector B is employed to equivalently represent a set S. That is to say, B∈{0,1}^{|X| indicates the presence or absence of certain values, such that B}ᵢ=(xᵢ∈S). Then, according to the De Finetti's Theorem, any joint distribution can be represented as follows:

p(B)=∫_{θ}p(θ)Πᵢ₌₁^{|X|p(B}ᵢ|θ). (7)

When θ is discrete and the summation is tractable, one can calculate p(B) in a closed form to support efficient maximum likelihood estimation on a given dataset_{src}. When θ is in a continuous domain, techniques like variational autoencoders (VAE) may be used to optimize the evidence lower-bound. The learning of (p(θ), p(B|θ)), may be performed by various techniques. In some non-limiting embodiments, rather than learning (p(θ), p(B|θ)), the embodiments adapt both q from p under the target constraints by implementing the MODEM framework.

To estimate the marginal distribution, a calculation of the marginal in an LVM model for the constraints in Eq (6) is considered. Note that by the conditional independence structure in:

$$p ( {B}_{i} ) = {\sum }_{\tilde{B} ∈ 0 , {1}^{\vert X \vert} , {\tilde{B}}_{i} = {B}_{i}} {\int }_{θ} p ( θ ) {\prod }_{j = 1}^{\vert X \vert} p ( {\tilde{B}}_{j} \vert θ ) = {\int }_{θ} p ( θ ) p ( {B}_{i} \vert θ ) ( {\sum }_{\tilde{B}} {\prod }_{j \neq i} p ( {\tilde{B}}_{j} \vert θ ) ) = {\int }_{θ} p ( θ ) p ( {B}_{i} \vert θ ) . \qquad ( 8 )$$

In equation (8), the change from the first to the second line is based on the interchangeability of summation and integration, while the last step is based on the fact that Σ_{{\tilde{B}}_{ⱼ}_{,j≠i}} Π_{j≠i} p(\tilde{B}ⱼ|θ)=Π_{j≠i} (Σ_{{\tilde{B}}_{ⱼ}_{}} p(\tilde{B}ⱼ|θ)) by independence of each factor and Σ_{{\tilde{B}}_{ⱼ}_{}} p(\tilde{B}ⱼ|θ)=1, ∀j≠i, due to the fact that the summation of probabilities over all events equals to 1. Thus, the marginal for element xᵢ only involves a subset of components in the overall model (7), which can be efficiently calculated.

To adapt the distribution p to a target domain, the conditional probability module p(B|θ) may be reused, since intuitively the generation process can be controlled via the control over the latent variable θ. Thus q(B) may be defined in the following form

q(B)=∫_{θ}q(θ)Πᵢ₌₁^{|X|}p(Bᵢ|θ), (9)

where q(θ) is a new distribution that will be learned and p(Bᵢ|θ) is a distribution that is “frozen” from an existing model. That is to say, the conditional components from p are “frozen” while adjusting the prior over θ only.

By plugging the module-reused parametrization of q(B) into Eq (6), the instantiation of MODEM for LVMs may be obtained as:

$${min}_{q ( θ )} KL q ( θ ) ‖ p ( θ ) , \qquad ( 10 )$$

where equation (10) is subject to the constraint:

∥ [symbol] _{θ˜q(θ)}[(Bₑ_{ᵢ}|θ)]−tᵢ∥₂≤ε,∀(eᵢ,tᵢ)∈C.

Note that minimizing KL(q(B)∥p(B)) between joint distributions is equivalent to minimizing KL(q(θ)∥p(θ)), where the latter form has a closed form solution when p(θ) and q(θ) are from exponential families, such as the multinomial or Gaussian distributions. Therefore, equation 10 can be solved in its primal form via penalty methods.

When θ is categorical and the integration in equation (7) is tractable, a uniform distribution may be employed for p(θ). When θ is continuous and VAE is employed, set type encoders, such as a transformer-based encoder or a multilayer perceptron (MLP) on a binary representation may be employed to parameterize the variational posterior. That is to say that the generative model may be implemented by a neural network.

### The MODEL Framework for Autoregressive Models

Since a joint distribution can be factorized in an autoregressive manner, autoregressive models may be employed, especially for modeling sequences. Despite the presence of a total ordering, which may not be desirable for unordered set modeling, autoregressive models are quite powerful for discrete set modeling. In particular, for this model, a set S with cardinality L may be treated as a sequence of L elements: S=s₁, s₂, . . . , S_{L}. Then an autoregressive model defines the distribution as:

p(S|L)=Πᵢ₌₁^{L}p(sᵢ|s_{<i},L). (11)

However, it is generally hard to compute the marginals for autoregressive models, due to the exponential growth of marginalization cost with respect to the sequence length. As such, in some embodiments, special structures to support efficient marginal computation may be introduced. For discrete sets, one reasonable assumption would be to enforce permutation invariance. For instance, the sequence S may be shuffled into S^{π} with a permutation π. The below equation (12) may hold for or any two permutations π and π′:

p(S^{π}|L)=Πᵢ₌₁^{L}p(s_{π}_{ᵢ}|s_{<π}_{ᵢ},L)=p(S^{π′}|L). (12)

Introducing permutation invariance into autoregressive models can be difficult, but one reasonably effective strategy is to use the following surrogate objective for p.

$$p = {arg max}_{p} {𝔼}_{S \sim {𝒟}_{src}} [ {𝔼}_{π \sim Uniform} [ p ( {S}^{π} ) ] ] \qquad ( 13 )$$

Robust learning may be leveraged to further reduce sample complexity.

With the permutation invariance assumption, the marginals can be calculated efficiently. Specially, equation (14) may be employed to calculate the marginal for a particular element x∈X:

$$p ( x ) = {\sum }_{L = 1}^{\vert X \vert} p ( L ) {\sum }_{S : \vert S \vert = L} p ( x ∈ S \vert L ) = {\sum }_{L = 1}^{\vert X \vert} p ( L ) {\sum }_{S : \vert S \vert = L} p ( {s}_{1} = x \vert L ) \times L . \qquad ( 14 )$$

In other words, the marginal p(x) may be calculated simply by accessing the probability of generating x in the first position. The exact permutation invariance might not have been achieved in p, and the marginal may be improved via additional computation. Note that one equation (14) may be “unrolled” to obtain the marginal via the probability of generating x in either the first or the second positions, according to equation (15):

p(x)=Σ_{L=1}^{|X|}p(L)(p₁(x|L)+(L−1)×Σ_{x′≠x}p₁(x′|L)p₂(x|x′,L)) (15)

The notation is somewhat overloaded to use p₁(x|L) to denote the probability of generating x in the first position in a set of cardinality L, and similarly p₂(x|x′,L) is for x at second position given L and first element x′. Unrolling one step increases the computational cost by a factor of O(|X|), which is generally acceptable. Unrolling further quickly becomes impractical, but the second order estimator may be sufficient in practice to balance between the estimation quality and computational cost.

Equation (15) enables adaptation under the assumption of permutation invariance. The marginal p(x) may be controlled via the probability of generating x in the first position. Equation (16) provides such an adaptation:

q(S)=p(|S|)q₁(s₁∥S|)Πᵢ₌₂^{|S|}p(sᵢ|s_{<i},|S|), (16)
where p is frozen (and reused) and q₁ is adapted. Thus, the marginal estimator for q becomes

$$q ( x ) = {\sum }_{L = 1}^{\vert X \vert} p ( L ) ( {q}_{1} ( x \vert L ) + ( L - 1 ) \times {\sum }_{{x}^{′} \neq x} {q}_{1} ( {x}^{′} \vert L ) {p}_{2} ( x \vert {x}^{′} , L ) ) . \qquad ( 17 )$$

Where p(L) and p₂(x|x′, L) are frozen and q₁(x|L) is adapted.

Again, in this case the modules in p are preserved and we only an additional q₁(·|·) needs to be learned, which is much easier than learning a full autoregressive model. Note that equation (6) can be done effectively optimized as:

$$min {{𝔼}_{L \sim p ( L )}}_{{q}_{1}} KL ( {q}_{1} ( \cdot \vert L ) ‖ {p}_{1} ( \cdot \vert L )$$

subject to:

q(eᵢ)−tᵢ_{₂}≤ε,∀(eᵢ,tᵢ)∈C, (18)
where the KL term is defined over multinomial distributions making it simple to solve. By plugging equation (17) into equation (18), the above optimization can be performed directly in its primal form via penalty methods.

For the parameterization of an autoregressive model, one property of discrete set modeling is permutation invariance. Transformer models (without positional encoding) may be employed for modeling permutation invariant data. Thus, neural network implemented transformer models may be employed for parameterization (or training). Note that although this only guarantees permutation invariance for each of the conditional marginals (i.e., p(sᵢ|s_{<i}^{π}^{_{<i}})=p(sᵢ|s_{<i}^{π′}^{_{<i}})), they may be useful in achieving equation (12) and obtaining good results.

### The MODEL Framework for Energy-Based Models

Energy-based models (EBMs) are highly expressive for modeling distributions. An unnormalized score function over the domain may be specified, enabling significant flexibility. EBMs may be particularly convenient for discrete set modeling via expressive set encoder parameterizations. Similar to LVMs discussed in above a binary vector B is employed to equivalently represent a set S in a similar manner. A set distribution can be simply defined through ƒ(B) as:

$${p}_{f} ( B ) = \frac{exp ( f ( B ) )}{{Z}_{p}} , {Z}_{f} = {\sum }_{B ∈ 0 , {1}^{\vert X \vert}} exp ( f ( B ) ) \qquad ( 19 )$$

where ƒ is the negative energy or score function, which can be a neural network.

In contrast to the LVMs and autoregressive models, where the models can be factorized and the module can be extracted explicitly, module factorization can be difficult in EBM from the score function ƒ(B), thus, making the module reuse becomes non-trivial. However, the module reuse can be naturally derived from the dual form of Eq. 6 with EBMs.

Specifically, given the constraints set C and denote ϕ(B)=[Bₑ_{₁}, Bₑ_{₂}, . . . , Bₑ_{_{|C|}}] and c=[t₁, t₂, . . . , t_{|C|}], plug this into the optimization of equation (6), leading to

$${min}_{q ∈ 𝒫} K L ( q ‖ {p}_{f} ) ,$$

subject to

∥E₂[ϕ(B)−c]∥₂≤ε, (20).

The dual form of equation (20) can be directly obtained as below (with constants omitted),

$${max}_{w} {w}^{⊤} c - log {\sum }_{B} exp ( {w}^{⊤} ϕ ( B ) + f ( B ) ) - ε {w}_{2} , \qquad ( 21 )$$

which is equivalent to the MLE for p_{ƒ}(B)p(c|B) with p(c|B)∝ exp(w^{T}ϕ(B)) with a single data point c. Note that w is adapted and ƒ(B) is frozen. Comparing to the primal form of equation (20), which conducts optimization over all valid distributions, the dual form of equation (21) may be optimized.

Moreover, via equation (21), the whole model ƒ(B) may be frozen and reused during adaptation, while a new component w^{T}ϕ(B) with w is the only learnable parameter, which has the size equals to the number of constraints. Due to the equivalence of the primal form of equation (20) and the dual form of equation (21), the optimal solution to equation (20) may be q(B)∝exp(w^{T}ϕ(B)+ƒ(B)), which means the module-reuse parametrization does not lose any flexibility.

Any ƒ may be employed to parameterize p. In some embodiments, a MLP is employed on the binary representation B without worrying about enforcing permutation invariance explicitly. As learning the discrete set generation for EBMs requires the sampling in discrete space, sampling from EBMs in discrete space may be employed for training both p and q, and use the same samplers for generating new samples from the learned models for simulation.

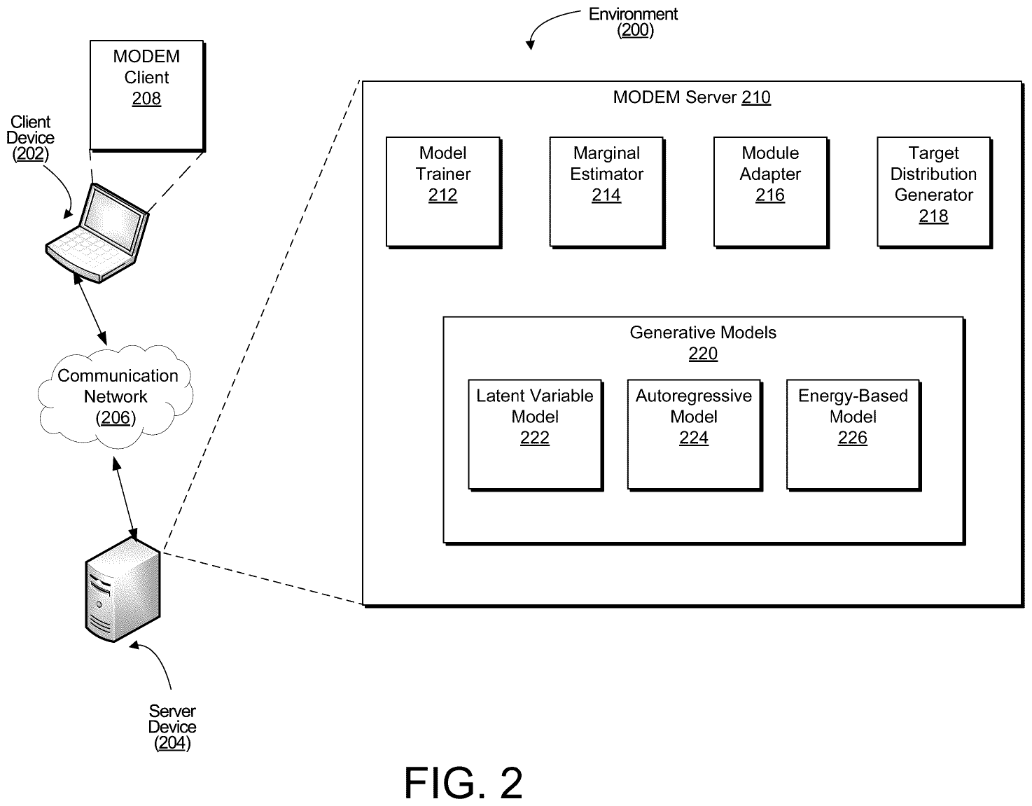

FIG. 2 depicts a block diagram of an example environment 200 that enables marginal distribution adaptation for discrete sets via module-oriented divergence minimization (MODEM), according to various embodiments. Environment 200 includes a client device 202 and a server device 204. A communication network 206 communicatively couples the client device 202 and the server device 204. The client device 202 may implement a MODEM client 208. The server device 204 may implement a MODEM server 210.

The MODEM server 210 may include a model trainer 212, a marginal estimator 214, a module adapter 216, and a target distribution generator 218. The MODEM server 210 may additionally include generative models 220. The generative models 220 may include a latent variable model (LVM) 222, an autoregressive model 224, and an energy-based model (EBM) 226. Each of the latent variable model 222, the autoregressive model 224, and the energy-based model 226 may be a generative model type.

The model trainer 212 is generally responsible for training each of the generative models 220 based on one or more source distributions. The marginal estimator 214 is generally responsible for estimating a marginal (e.g., a marginal distribution) based on a marginal constraint (e.g., a marginal specification). The marginal estimator 214 may estimate the marginal differently for each of the generative models 220. The module adapter 216 is generally responsible for adapting one or more modules of each of the generative models 220 based on the estimated marginal. The module adapter 216 may additionally generate an “adapted” generative model based on the updated (e.g., adapted) modules and unadapted (e.g., frozen) modules of one or more of the generative models 220. The target distribution generator 218 is generally responsible for generating a target distribution based on the adapted generative model. Because the modules of each of the generative modules 220 has been trained on the source distribution, and a portion of the modules are “frozen” when used in the adapted generative model, the generated target distribution at least approximately preserves or conserves correlations (e.g., co-occurrences) of the source distribution. Because another portion of the modules employed in the adapted generative model, the generated target distribution conforms to the marginal constraint that the adapted modules are adapted to.

More specifically, a source distribution (e.g., [symbol] _{src} of FIG. 1) may be provided to the MODEM server 210. For example, the MODEM client 208 may provide the source distribution to the MODEM server 210. In such embodiments, the MODEM server 210 may receive the source distribution from the MODEM client 208. The source distribution may be a source set and/or a source dataset. The source distribution may be associated with a plurality of objects and/or a plurality of items. The source distribution (or the source data set) may be a “set of sets,” where each set of the set of sets includes one or more of the objects (or items). In a non-limiting embodiment, each set in the set of sets may include the objects (or items) in a customer's shopping cart for an online retailer. Each set may correspond to a separate customer (e.g., see FIG. 1). A first object of the plurality of objects may occur at a source frequency in the source set. For instance, the first object may appear in the sets of the set of sets at the source frequency for the first object. The source distribution may encode a set of co-occurrence frequencies for a plurality of object pairs of the plurality of objects. For instance, the co-occurrence of a pair or objects (or items) may be a co-occurrence in a set within the set of sets.

The model trainer 212 may train at least one of the generative models (e.g., the latent variable model 222, the autoregressive model 224, and/or the energy-based model 226) based on the source distribution. Training a generative model may include training a generative model to generate a target distribution based on the source distribution. Each of the generative modules may include a plurality of modules. Training the models may include training each of the modules of the generative models based on the source distribution (e.g., the source set). The generative models may be parameterized models. Thus, training the source distribution may include determining values for the model's parameters (e.g., parameterizing the model). At least one the generative models may be implemented by a neural network. Accordingly, training a generative model may include training one or more neural networks.

A request to generate a target distribution (e.g., [symbol] _{tgt} of FIG. 1) may be provided to the MODEM server 210. For example, the MODEM client 208 may provide the request to generate the target distribution to the MODEM server 210. In such embodiments, the MODEM server 210 may receive the request to generate the target distribution from the MODEM client 208. The request may indicate a marginal constraint (e.g., a marginal constraint specification) for the target distribution. The marginal constraint may indicate a target frequency for the first object that is separate from the source frequency for the first object. That is, the requesting party may intend for the first object to occur in the sets of the set of sets of the target distribution at the target frequency.

The request may indicate (or select) a generative model from the generative models 220. For instance, the request may indicate at least one of the latent variable model 222, the autoregressive models 224, and/or the energy-based model 226. The MODEM server 210 may access the selected generative model. Because each of the generative models has been trained on the source distribution, the accessed (and trained) generative model may be referred to as a source generative model. Each of the generative models 220 may include a set of modules. Thus, each of the modules in a models set of modules may be trained on the source distribution. In some embodiments, each of the generative models may include at least a first module and a second module.

The marginal estimator 214 may estimate a marginal distribution based on the marginal constraint and the selected generative model (or model type). The module adapter 216 may update (or adapt) at least a portion of the modules of the set of modules of the selected and/or accessed generative model (e.g., the source generate model and/or model type). Other modules of the set of modules may be unadapted or “frozen.” For instance, the module adapter 216 may update (or adapt) the second module of the set of modules, while leaving the first module unadapted. Updating the second module may be based on a constrained divergence objective function that indicates a variational distance between the first and second modules. The module adapter 216 may further generate an adapted generative module based on the adapted and unadapted modules. For instance, the module adapter 216 may generate an adapted generative module that includes the “frozen” (or unadapted) first module and the adapted second module. The “frozen” first module may be associated with the set of co-occurrence frequencies for the plurality of object pairs. The updated second module may be associated with the target frequency of the first object.

The target distribution generator 218 may generate the target distribution (or target dataset) based on the adapted generative model. The first object occurs at the target frequency in the target dataset and the target dataset encodes the set of co-occurrence frequencies for the plurality of object pairs. That is, the target distribution preserves the correlations of the source distribution and conforms to the marginal constraint. The MODEL server 210 may provide the generated target distribution to the MODEM client 208.

### Example Methods

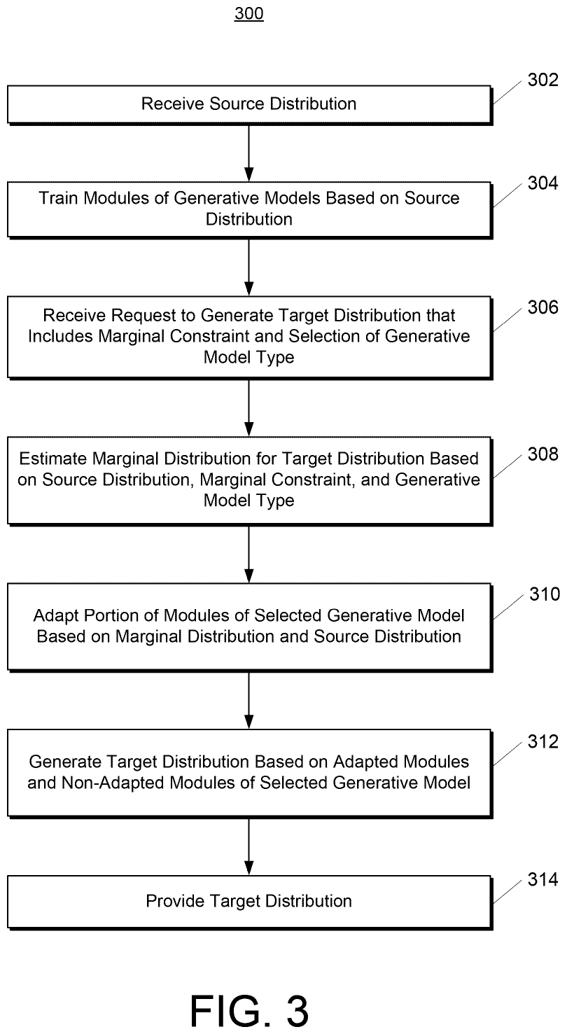

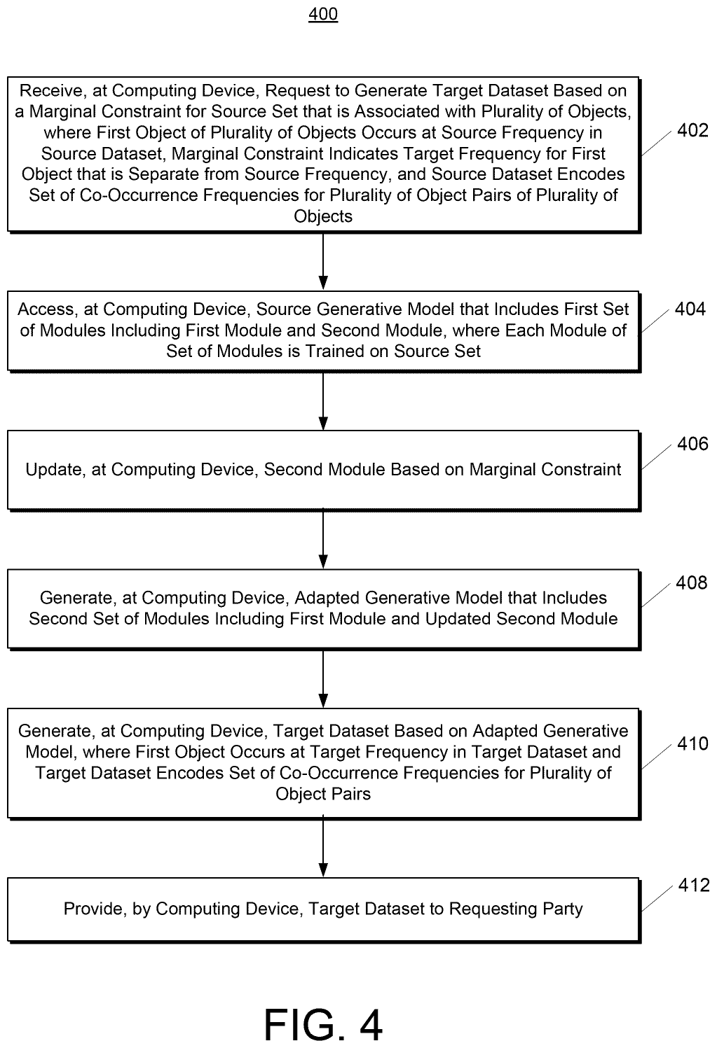

FIGS. 3-4 depict flowcharts for various methods implemented by the embodiments. Although the flowcharts of FIGS. 3-4 depict steps performed in a particular order for purposes of illustration and discussion, the methods of the present disclosure are not limited to the particularly illustrated order or arrangement. Various steps of the methods of FIGS. 3-4 can be omitted, rearranged, combined, and/or adapted in various ways without deviating from the scope of the present disclosure. A computing device (e.g., client device 208 and/or server device 204 of FIG. 2) or a combination of computing devices may perform at least a portion of the steps included in the flowcharts of FIGS. 3-4. Various software components and/or modules implemented by the computing devices (e.g., MODEM server 210 and/or MODEM client 208) may implement at least a portion of the steps included in the flowcharts of FIGS. 3-4.

FIG. 3 depicts a flowchart diagram of an example method 300 for generating a target distribution based on a source distribution and a marginal constraint according to example embodiments of the present disclosure. Method 300 begins at block 302, where a source distribution is received. For example, a source distribution is received at a MODEM server (e.g., MODEM server 210 of FIG. 2). The source distribution (e.g., [symbol] _{src} of FIG. 1) may be received at a computing device (e.g., server computing device 204 of FIG. 2). The source distribution may be received from a MODEM client (e.g., MODEM client (e.g., 208 of FIG. 2). The source distribution may be received from another computing device (e.g., client device 202 of FIG. 2). The source distribution may be a source set and/or a source dataset. The source distribution may be associated with a plurality of objects and/or a plurality of items. The source distribution (or the source data set) may be a “set of sets,” where each set of the set of sets includes one or more of the objects (or items). In a non-limiting embodiment, each set in the set of sets may include the objects (or items) in a customer's shopping cart for an online retailer. Each set may correspond to a separate customer (e.g., see FIG. 1). A first object of the plurality of objects may occur at a source frequency in the source set. For instance, the first object may appear in the sets of the set of sets at the source frequency for the first object. The source distribution may encode a set of co-occurrence frequencies for a plurality of object pairs of the plurality of objects. For instance, the co-occurrence of a pair or objects (or items) may be a co-occurrence in a set within the set of sets.

At block 304, modules of one or more generative models (e.g., generative models 220 of FIG. 2) may be trained on and/or based on the source distribution. A model trainer (e.g., model trainer 212 of FIG. 2) may train at least one of the generative models (e.g., the latent variable model 222, the autoregressive model 224, and/or the energy-based model 226 of FIG. 2) based on the source distribution. Training a generative model may include training a generative model to generate a target distribution based on the source distribution. Each of the generative modules may include a plurality of modules. Training the models may include training each of the modules of the generative models based on the source distribution (e.g., the source set). The generative models may be parameterized models. Thus, training the source distribution may include determining values for the model's parameters (e.g., parameterizing the model). At least one the generative models may be implemented by a neural network. Accordingly, training a generative model may include training one or more neural networks.

At block 306, a request to generate a target distribution may be received at the computing device. The request may include a marginal constraint (e.g., a marginal constraint specification). The marginal constraint may indicate a target frequency for the first object that is separate from the source frequency for the first object. That is, the requesting party may intend for the first object to occur in the sets of the set of sets of the target distribution at the target frequency. The request may additionally indicate a selection of a model type (e.g., the latent variable model 222, the autoregressive model 224, and/or the energy-based model 226 of FIG. 2).

At block 308, block 308, a marginal distribution for the target distribution may be estimated. A marginal estimator (e.g., marginal estimator 214 of FIG. 2) may estimate the marginal distribution. Estimating the marginal distribution may be based on at least one of the source distribution, the marginal constraint, and/or the selected generative model type. At block 310, a portion of the trained modules of the selected generative model type may be adapted (e.g., updated) based on at least one of the marginal distribution and/or the source distribution. A module adapter (e.g., module adapter 216) may adapt the portion of the modules. Note that another portion of the trained modules may be “frozen” or unadapted (e.g., non-adapted modules).

At block 312, the target distribution is generated based on the adapted modules and the non-adapted (e.g., frozen or unadapted) modules of the selected generative model. A target distribution generator (e.g., target distribution generator 218 of FIG. 2) may generate the target distribution. The first object may occur at the target frequency in the target distribution. The target distribution may encode the set of co-occurrence frequencies for the plurality of object pairs.

FIG. 4 depicts a flowchart diagram of another example method 400 for generating a target distribution based on a source distribution and a marginal constraint according to example embodiments of the present disclosure. Method 400 begins at block 402, where a request to generate a target dataset is received at a computing device. The request may be based on (or indicate) a marginal constraint for a source dataset that is associated with a plurality of objects. A first object of a plurality of objects may occur at a source frequency in the source dataset. The marginal constraint may indicate a target frequency for the first object that is separate from the source frequency. The source dataset may encode a set of co-occurrence frequencies for a plurality of object pairs of the plurality of objects.

At block 404, a source generative model may be accessed at the computing device. The source generative model may include a first set of modules. The first set of modules may include a first module and a second module. Each module of the set of modules may be trained on (or based on) the source dataset. At block 406, the second module may be updated at the computing device. Updating the second module may be based on the marginal constraint. At block 408, the computing device may generate an adapted generative model. The adapted generative model may include a second set of modules including the first (unadapted and/or frozen) module and the updated second module. At block 410, the computing device may generate the target dataset. Generating the target distribution may be based on the adapted generative model. The first object may occur at the target frequency in the target dataset. The target dataset may encode the set of co-occurrence frequencies for the plurality of object pairs. At block 412, the computing device may provide the target data to a party that requested the target dataset. Providing the target dataset may include providing the target dataset to another computing device that transmitted the request to generate the target dataset.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method comprising:
receiving, at a computing device, a request to generate a target dataset based on a marginal constraint for a source dataset that is associated with a plurality of objects, wherein a first object of a plurality of objects occurs at a source frequency in the source dataset, the marginal constraint indicates a target frequency for the first object that is separate from the source frequency, and the source dataset encodes a set of co-occurrence frequencies for a plurality of object pairs of the plurality of objects;
accessing, at the computing device, a source generative model that includes a first set of modules including a first module and a second module, wherein each module of the first set of modules is trained on the source dataset;
updating, at the computing device, the second module based on the marginal constraint;
generating, at the computing device, an adapted generative model that includes a second set of modules including the first module and the updated second module; and
generating, at the computing device, the target dataset based on the adapted generative model, wherein the first object occurs at the target frequency in the target dataset and the target dataset encodes the set of co-occurrence frequencies for the plurality of object pairs.

2. The method of claim 1, wherein updating the second module comprises:
updating the second module based on a constrained divergence objective function that indicates a variational distance between the first and second modules.

3. The method of claim 1, wherein the source generative model and the adapted generative model are latent variable models.

4. The method of claim 1, wherein the source generative model and the adapted generative model are autoregressive models.

5. The method of claim 1, wherein the source generative model and the adapted generative model are energy-based models.

6. The method of claim 1, wherein the first module is associated with the set of co-occurrence frequencies for the plurality of object pairs.

7. The method of claim 1, wherein the second module is associated with the target frequency of the first object.

8. The method of claim 1, wherein updating the second module comprises:
receiving, at the computing device, the source distribution; and
training, at the computing device, the source generative model based on the received source distribution.

9. The method of claim 8, wherein training the source generative model comprises:
training, at the computing device, a neural network that implements the source generative mode.

10. The method of claim 1, further comprising:
providing, from the computing device to another computing device that transmitted the request to generate the target distribution, the target distribution.

11. A computing system, comprising:
one or more processors; and
one or more non-transitory computer-readable media that, when executed by the one or more processors, cause the computer system to perform operations, the operations comprising:
receiving a request to generate a target dataset based on a marginal constraint for a source dataset that is associated with a plurality of objects, wherein a first object of a plurality of objects occurs at a source frequency in the source dataset, the marginal constraint indicates a target frequency for the first object that is separate from the source frequency, and the source dataset encodes a set of co-occurrence frequencies for a plurality of object pairs of the plurality of objects;
accessing a source generative model that includes a first set of modules including a first module and a second module, wherein each module of the set of modules is trained on the source dataset;
updating the second module based on the marginal constraint;
generating an adapted generative model that includes a second set of modules including the first module and the updated second module; and
generating the target dataset based on the adapted generative model, wherein the first object occurs at the target frequency in the target dataset and the target dataset encodes the set of co-occurrence frequencies for the plurality of object pairs.

12. The computing system of claim 11, wherein updating the second module comprises:
updating the second module based on a constrained divergence objective function that indicates a variational distance between the first and second modules.

13. The computing system of claim 11, wherein the source generative model is at least one of a latent variable model, an autoregressive model, or an energy-based model.

14. The computing system of claim 11, wherein the first module is associated with the set of co-occurrence frequencies for the plurality of object pairs and the second module is associated with the target frequency of the first object.

15. The computing system of claim 11, wherein updating the second module comprises:
receiving the source distribution; and
training the source generative model based on the received source distribution

16. The computing system of any of claim 11, wherein training the source generative model comprises:
training a neural network that implements the source generative mode.

17. The computing system of claim 11, wherein the operations further comprise:
providing the target distribution to a computing device that transmitted the request to generate the target distribution.

18. One or more tangible non-transitory computer-readable media storing computer-readable instructions that when executed by one or more processors cause the one or more processors to perform operations, the operations comprising:
receiving, at a computing device, a request to generate a target dataset based on a marginal constraint for a source dataset that is associated with a plurality of objects, wherein a first object of a plurality of objects occurs at a source frequency in the source dataset, the marginal constraint indicates a target frequency for the first object that is separate from the source frequency, and the source dataset encodes a set of co-occurrence frequencies for a plurality of object pairs of the plurality of objects;
accessing, at the computing device, a source generative model that includes a first set of modules including a first module and a second module, wherein each module of the set of modules is trained on the source dataset;
updating, at the computing device, the second module based on the marginal constraint;
generating, at the computing device, an adapted generative model that includes a second set of modules including the first module and the updated second module; and
generating, at the computing device, the target dataset based on the adapted generative model, wherein the first object occurs at the target frequency in the target dataset and the target dataset encodes the set of co-occurrence frequencies for the plurality of object pairs.

19. The one or more tangible non-transitory computer-readable media of claim 18, wherein updating the second module comprises:
updating the second module based on a constrained divergence objective function that indicates a variational distance between the first and second modules.

20. The one or more tangible non-transitory computer-readable media of claim 18, wherein the source generative model is at least one of a latent variable model, an autoregressive model, or an energy-based model.
